(19) United States
(12) Patent Application Publication
(10) Pub. No.: US 2004/0249011 A1
(43) Pub. Date: Dec. 9, 2004

(54) Moisture permeable membrane and method of making

(75) Inventor: Thomas C. Colasanto, Tolland, CT (US)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(73) Assignee: Dartex Coatings, Inc., Slatersville, RI (US)

(21) Appl. No.: 10/454,688

(22) Filed: Jun. 4, 2003

(51) Int. Cl. C08G 18/00

(52) U.S. Cl. 521/155; 525/452; 210/500.21

(57) ABSTRACT

The invention is directed to copolymers, which can be formed into water vapor permeable, water resistant membranes suitable for use in garments, tents, etc. A copolymer includes a random distribution of a soft segment comprising a hydrophilic soft segment and up to about 30 wt % of a hydrophobic soft segment, a hard segment, a cross-linking segment comprising a pendant alkoxysilane, and at least two terminal groups comprising at least one of an amine and an isocyanate having a functionality of at least 2, wherein a number average molecular weight (Mₙ) of the copolymer is at least about 10,000.

### BACKGROUND OF THE INVENTION

This invention relates to copolymers, which can be formed into water vapor permeable, water resistant membranes suitable for use in garments, tents, etc. The membranes are particularly suitable for applications where high stretch and durability are desirable. Copolymers of the invention have additional benefits of ease of manufacture and reduced toxicity during the manufacturing process. Typically, such membranes will be bonded on one or both sides to fabric.

Water resistant, moisture vapor permeable (breathable) membranes and textile coatings are desirable in garments because of the increased comfort provided. Examples of desirable application of these materials include: (i) outdoor garments, including sportswear, active wear and rainwear; ii) industrial clean room garments such as those used in microchip and pharmaceutical production facilities; iii) medical products including wound dressings, medical garments, bed sheets, and surgical drapes which are breathable but provide a fluid barrier; iv) protective military garments; v) tents; vi) natural and synthetic leather coatings; vii) glove inserts; and viii) shoe insulation.

Generally, the two types of water-resistant, breathable barriers are i) microporous films and coatings and ii) monolithic films and coatings. The first type, microporous films and coatings, provides breathability by the presence of pores, which are too small for water droplets to pass through, but large enough to be permeable to moisture vapor. Examples of such films and textile coatings include Gore-Tex (microporous polytetrafluorethylene, W. L. Gore, USA, see, e.g., U.S. Pat. No. 4,194,041), Entrant (woven nylon fabric coated with a microporous polyurethane film, Toray, Japan, U.S. Pat. No. 4,429,000), Ultrex (microporous polyurethane, Burlington, USA), Breathe (microporous polyurethane, UCB, Belgium), Exeltech (microporous polyurethane, Unitika, Japan) and Celtech (micro porous poly(amino acid), Unitika, Japan, U.S. Pat. No.4,636,424).

The second type, comprising monolithic films and coatings, is solid (lacking micropores). Breathability results from molecular composition and molecular structure. Examples include Sympatex (monolithic polyester, Akzo, Netherlands), Witocoflex (monolithic polyurethane, Baxenden, U.K.) and Bion-II (monolithic polyurethane, Goldschmidt, Germany, see, e.g., U.S. Pat. No. 5,389,430).

In addition to moisture vapor permeability and water resistance, other desirable characteristics of these films and coatings, particularly strength, stretchability and abrasion resistance, dictate their suitability for particular applications. For example, when laminated to, or coated onto a highly stretchable substrate (e.g., Lycra-Spandex), the coating or laminate must stretch at least as much as the substrate, or it will either tear or detract from the elasticity of the substrate.

In addition to the performance requirements for moisture vapor permeable films and coatings, there are also many process related requirements during the commercial coating process, which eventually determine the quality, aesthetics, and the overall performance of the system. The following is a list of various desirable performance related requirements for moisture vapor permeable coatings: 1) high water vapor transmission rate; 2) water resistance or impermeability to other fluids, especially blood; 3) wind resistance; 4) high stretchability; 5) good film strength (mechanical integrity); 6) soft, dry touch; 7) good drape; 8) machine washability (including industrial washing with hot water and bleach); 9) dry cleanability; 10) good overall durability (abrasion resistance, thermal, hydrolytic, oxidative and ultraviolet stability); 11) lightweight; and 12) barrier to microbes and/or other microorganisms (medical applications).

In the prior art, it has been difficult to combine most or all these properties into one coating material and even more difficult to combine these properties into self-supporting membranes. For example, although microporous polytetrafluoroethylene, which has been made microporous by biaxial stretching, may exhibit high breathability, it lacks stretchability. Similarly, monolithic polyester (“Sympatex”) can suffer from poor stretchability. Another disadvantage of microporous polytetrafluoroethylene is that water resistance is lost when it is soiled by surface tension lowering agents, such as those contained in perspiration and/or body oils.

Typical water resistant materials that can be stretched are disadvantageously deficient in strength and resistance to abrasion and are offered commercially as thin films, which are coated onto fabrics by lamination. Where stretch characteristics of such films are insufficient for lamination to highly stretchable fabrics, special methods must be employed to attach the films to stretched fabrics. For example, U.S. Pat. No. 4,935,287 discloses a stretchable laminate construction based on an elastic fabric and substantially non-elastic film.

Accordingly, there exists a need for films and membranes, which combine characteristics of high moisture vapor permeability, water resistance, wind resistance, elasticity, strength, and resistance to abrasion.

All references cited herein are incorporated herein by reference in their entireties.

### BRIEF SUMMARY OF THE INVENTION

Accordingly, the invention provides a copolymer comprising a random distribution of:

a soft segment comprising a hydrophilic soft segment and optionally a hydrophobic soft segment, wherein the hydrophobic soft segment constitutes up to 30 wt % of the copolymer;

a hard segment;

a cross-linking segment comprising a pendant alkoxysilane; and

at least two terminal groups comprising at least one of an amine and an isocyanate having a functionality of at least 2,

wherein a number average molecular weight (Mn) of the copolymer is at least about 10,000.

Also provided is a copolymer, which is a product of the random polymerization of:

(a) a soft segment precursor, comprising at least two soft segment terminal groups, a hydrophilic soft segment and up to 30 wt % of a hydrophobic soft segment;

(b) a hard segment precursor, comprising at least two hard segment terminal groups and a hard segment; and

(c) a cross-linking segment precursor, comprising at least two cross-linking segment terminal groups and a cross-linking segment comprising a pendant alkoxysilane,

wherein the at least two soft segment terminal groups, the at least two hard segment terminal groups, and the at least two cross-linking segment terminal groups are members selected from the group consisting of amines, polyamines, isocyanates, and polyisocyanates, provided that the amines or the polyamines are reacted with the isocyanates or the polyisocyanates at an amino/isocyano group molar ratio of 1:1, and wherein the number average molecular weight of the copolymer is at least about 10,000.

Further provided is a copolymer of the formula:

NH₂—(A1-B3)ₓ-(A1-B2)_{y}-(A2-B2)_{z}-(C-B2)ₙ-(B1-B2)ₘ-(A1)-NH₂

where A1 is a hydrophilic soft segment, A2 is a hydrophobic soft segment, B1 is an amino terminated hard segment, B2 is an isocyanate terminated hard segment, B3 is a polyfunctional element, C is a cross-linking segment comprising a pendant alkoxysilane, x=1, y=14, z=0.1, n=2, and m=10, provided that A1, A2, B1, B2, B3, and C are distributed randomly, wherein the hydrophobic soft segment constitutes up to 30 wt % of the copolymer.

Also provided is a method of making a copolymer of the invention, the method comprising:

providing a reaction vessel;

combining in the reaction vessel: (a) a soft segment precursor, the soft segment precursor comprising a hydrophilic portion and up to 30 wt % of a hydrophobic portion, (b) a hard segment precursor comprising a hard segment, and (c) a cross-linking segment precursor comprising a cross-linking segment having a pendant alkoxysilane, wherein each of the soft segment precursor, the hard segment precursor, and the cross-linking segment precursor comprise at least two functional groups having a functionality of at least 2, the at least two functional groups include an amino group and/or an isocyano group;

adding to the reaction vessel a polar organic solvent; and

reacting the at least two functional groups to form the copolymer.

Still further provided is a cross-linked copolymer and a method for making it, wherein cross-linking is effectuated by coupling of pendent alkoxysilanes in a presence of H₂O.

Still further provided is a membrane formed from a cross-linked copolymer of the invention, wherein the membrane has a moisture vapor permeability of at least about 250 g/m²-24hr.

A method of making the membrane is also provided, the method comprising:

providing a reaction vessel;

combining in the reaction vessel poly(oxyethylene) diamine in an amount from about 20 wt % to about 70 wt %; poly(oxypropylene) diamine in an amount from about 0 wt % to about 30 wt %; 4,4′-methylenebiscyclohexanamine in an amount from about 0 wt % to about 20 wt %; 1.3-bis(1-isocyanato-1-methylethyl) benzene in an amount from about 15 wt % to about 45 wt %; 1,6-diisocyanatohexane, homopolymer in an amount from 0.25 wt % to about 3 wt %; and N-(3-(trimethoxysilyl) propyl)-1,2-ethanediamine in an amount for about 0.5 wt % to about 5 wt %;

adding isopropanol to the reaction vessel to form a viscous copolymer solution;

shaping the viscous copolymer solution to form a thin layer;

substantially removing the isopropanol; and

curing the copolymer to obtain a cross-linked copolymer by exposure to moisture, thereby forming the moisture vapor permeable membrane.

Thus, the invention relates to copolymers, which can be used to prepare membranes which are highly moisture vapor permeable, water resistant and wind resistant, and which exhibit the highly desirable qualities of stretchability and durability mentioned above. Other advantages include ease of preparation and low hazard associated with the manufacture of the copolymer and products containing the copolymer. The copolymers of the invention are preferably resistant to abrasion.

Copolymers of the invention are formed by polymerization and cross-linking (curing). Copolymers of the invention comprise soft segments, hard segments, and cross-linking segments, which are covalently linked in a random order primarily by urea or urethane type linkages. Usually, a copolymer formed during polymerization is in a form that can be further manipulated into a desired shape. For example, a copolymer can be non-solid and castable into a sheet. A cross-linked copolymer of the invention is obtained upon curing by covalent bonding of the cross-linking segments.

The desirable characteristics of membranes formed from the cross-linked copolymer of the invention can be adjusted by the modifying the type and relative amounts of soft segments, hard segments, and cross-linking segments. In preferred embodiments, soft segments are hydrophilic polyethers (or polyesters), which confer moisture vapor permeability, flexibility and stretch. Hydrophobic soft segments can optionally be included to adjust hydrophilicity of the final product. For example, swelling of hydrophilic membranes comprised of hydrophilic soft segments due to absorption of moisture can be reduced by the incorporation of hydrophobic soft segments. Hard segments add to the stiffness and rigidity of the copolymer as well as to the strength and thermal and hydrolytic stability of the final product. Cross-linking within a copolymer chain and between separate copolymer chains contributes to strength, resilience, and chemical and heat resistance of the final product.

The invention particularly relates to cured moisture vapor permeable membranes comprising cross-linked copolymers of the form:

poly([A]ₓ-ran-[B]_{y}-ran-[C]_{z})

where A represents a hydrophilic soft segment and optionally a hydrophobic soft segment; B represents a hard segment; C represents a cross-linking segment comprising at least one pendant silane ester, wherein A, B, and C are linked in a random order by polar linking groups comprising at least one of an amine and an isocyanate having a functionality of at least 2, and wherein curing is accomplished by coupling of the pendant silane esters in a reaction which occurs subsequent to polymerization of segments and formation of the copolymer into the desired shape.

The invention embraces a variety of starting materials and copolymer compositions. Membranes comprising copolymers of the invention are moisture vapor permeable, water-resistant and wind-resistant. Additional characteristics which make the membranes desirable for a broad range of applications, particularly garments, include high stretch, soft hand and durability. It will be apparent that particular compositions of the invention are used where minimization of exposure hazards to workers is an important consideration. Similarly, other compositions of the invention may be preferred where cost of materials is the predominant consideration. In preferred embodiments, the invention also provides for ease of preparation and manufacture. A desired combination of these characteristics is attained by choice of starting material.

The foregoing features and advantages of the invention will be further apparent in view of the following detailed description.

### DETAILED DESCRIPTION OF THE INVENTION

The invention herein disclosed was driven by the desire to develop copolymers for manufacturing water vapor permeable, water resistant membranes. The invention flows from the surprising discovery that a copolymer comprising a random distribution of: (1) a soft segment comprising a hydrophilic soft segment and up to 30 wt %, preferably up to about 25 wt. % more preferably up to about 20 wt %, still more preferably 0-10 wt %, even more preferably 1-5 wt % of a hydrophobic soft segment; (2) a hard segment; (3) a cross-linking segment comprising a pendant alkoxysilane; and (4) at least two terminal groups comprising at least one of an amine and an isocyanate having a functionality of at least 2, wherein a number average molecular weight (Mₙ) of the copolymer is at least about 10,000, possess the desired moisture vapor permeability, flexibility and stretch characteristics upon curing.

Preferred copolymers of the invention have the following general formula:

T-[A-P]ₓ-[B-P]_{y}-[C]_{z}-T

where A represents a hydrophilic soft segment and optionally a hydrophobic soft segment; B represents a hard segment; and C represents a cross-linking segment comprising at least one pendant silane ester, wherein A, B, and C are linked in a random order; P is a linking group which is at least one of a urea based linking group and urethane linking group; T is a terminal group including an amine, a hydroxyl and/or an isocyanate, preferably an amine and/or an isocyanate. These terminal groups react during polymerization reaction to form polar linking groups P, which connect A, B, and C to produce a random co-polymer. For example, reaction of a terminal amine with a terminal isocyanate results in formation of a urea linkage of the following structure:

(—N—C(=0)-N—).

Reaction of a terminal hydroxy with a terminal isocyanate results in a urethane linkage of the following structure:

(—O—C(=0)-N—).

Copolymers of the invention comprise soft segments, hard segments and cross-linking segments randomly linked, e.g., (-A-B-C-A-B-C-), (-A-C-B-A-C-B-), or (-A-A-C-B-A-C-C-), etc., and are particularly advantageous when used as moisture vapor permeable, water-resistant membranes. Preferably, the soft segments of the present invention are hydrophilic. The copolymers can optionally further comprise hydrophobic soft segments to reduce swelling of membranes into which they are incorporated upon exposure to moisture. Each soft and hard segment comprises at least one monomeric unit or a subunit.

The term “soft segment” is well known in the art and relates to an element of a copolymer, which imparts flexibility to the chain. The term “soft segment” can be further characterized as an amorphous material with a low T_{g}, e.g., a T_{g} not higher than ambient temperature.

Similarly, the term “hard segment” is also well known and relates to an element of a copolymer, which imparts resistance properties, e.g., resistance to bending or twisting. The term “hard segment” can be further characterized as a crystalline or glassy material with a T_{g} above ambient temperature.

Although copolymers can be cross-linked through chain branching where polyisocyanate and/or polyamine precursors are employed in the polymerization reaction, as used herein, cross-linking refers to covalent linkages between copolymer chains, which are formed by a latent curing mechanism. The latent curing mechanism provides for formation of cross-links within and between copolymer chains after the copolymer has been formed into a desired shape. A copolymer formed in the polymerization step has the capacity to undergo cross-linking, but reaction conditions that permit the cross-linking reaction are typically provided after the copolymer has been formed into the desired configuration.

Copolymers of the invention are formed by polymerization followed by cross-linking. In the polymerization step, a hard segment, a soft segment and cross-linking segment starting materials or precursors comprising terminal isocyanates and amines are reacted to form random copolymers wherein the segments are joined or linked primarily by urea linkages. Cross-linking of the cross-linking segments occurs when reaction conditions are provided which promote the cross-linking reaction. Typically, this occurs after the copolymer is in a desired configuration.

It will be apparent that the molar ratio of reactive isocyanates and reactive amines in the polymerization step will, in general, be approximately 1:1.

In certain embodiments of the present invention, the copolymer is a product of random polymerization of: (a) a soft segment precursor, comprising at least two soft segment terminal groups, a hydrophilic soft segment and a hydrophobic soft segment in an amount up to 30 wt %, (b) a hard segment precursor, comprising at least two hard segment terminal groups and a hard segment, and (c) a cross-linking segment precursor, comprising at least two cross-linking segment terminal groups and a cross-linking segment comprising a pendant alkoxysilane, wherein the at least two soft segment terminal groups, the at least two hard segment terminal groups, and the at least two cross-linking segment terminal groups are members selected from the group consisting of amines and isocyanates (e.g., amines, polyamines, isocyanates and polyisocyanates), provided that the amines are reacted with the isocyanates at an amine/isocyanate group molar ratio of 1:1, and wherein the number average molecular weight of the copolymer is at least about 10,000, more preferably about 20,000. Molecular weights below about 10,000 might be suitable provided that the resulting product has adequate film-forming properties in the uncured state and adequate cross-link density in the cured state.

In certain embodiments, the hydrophilic soft segment constitutes 20-70 wt %, alternatively 40-70 wt %, of the dry weight of the polymerization composition. In addition to the hydrophilic soft segment, the soft segment can optionally further comprise a hydrophobic soft segment in an amount up to 30 wt %, preferably up to about 25 wt. % more preferably up to about 20 wt %, still more preferably 0-10 wt %, even more preferably 1-5 wt %, based on the dry weight of the polymerization composition.

Preferably, the hard segment is in molar excess of the soft segment. The copolymer of the present invention can also include at least one additional hard segment which further comprises a polyfunctional element adapted to prevent premature termination of a backbone of the copolymer by forming at least three urea linking groups, wherein the polyfunctional element is at least one of a polyisocyanate and a polyamine.

In certain embodiments of the present invention, a copolymer comprises hydrophilic soft segments, hydrophobic soft segments, hard segments derived from isocyanate terminated moieties, hard segments derived from amine termination moieties and cross-linking segments and is represented by the formula:

NH₂-(A1-B3)ₓ-(A1-B2)_{y}-(A2-B2)_{z}-(C-B2)ₙ-(B1-B2)ₘ-(A1)-NH₂

where A1 is a hydrophilic soft segment, A2 is a hydrophobic soft segment, B1 is an amino terminated hard segment, B2 is an isocyanate terminated hard segment, B3 is a polyfunctional element, C is a cross-linking segment comprising a pendant alkoxysilane, x=1, y=14, z=0.1, n=2, and m=10, provided that A1, A2, B1, B2, B3, and C are distributed randomly, wherein the hydrophobic soft segment constitutes up to 30 wt % of the copolymer.

Preferably, the hydrophilic soft segment is poly(oxyethylene) diamine with a number average molecular weight of about 900 present in an amount of from about 55 wt % to about 65 wt %, the hydrophobic soft segment is poly(oxypropylene) diamine with a number average molecular weight of about 2000 present in an amount of from about 1 wt % to about 2 wt %, the amino terminated hard segment is 4,4′-methylenebis-cyclohexanamine present in an amount from about 8 wt % to about 10 wt %, the isocyanate terminated hard segment is 1,3-bis(1-isocyanato-1-methylethyl) benzene present in an amount from 25 wt % to about 30 wt %, the polyfunctional element is 1,6-diisocyanatohexane homopolymer with a number average molecular weight of about 330 present in an amount from about 0.5 wt % to about 1.5 wt %, and the cross-linking segment is N-(3-(trimethoxysilyl)propyl)-1,2-ethanediamine present in an amount from about 1.5 wt % to about 2.5 wt %.

In preferred embodiments, polymerization of the copolymer of the present invention is accomplished by reacting segment subunits having terminal isocyanates with segment subunits having terminal amines. For example, a difunctional isocyanate of the following structure:

O══C══N—R¹—N══C══O

is reacted with a diamine of the following structure:

H₂N—R²—NH₂

R₁ and R₂ can represent soft segments, hard segments, and cross-linking segments. The resulting linkages of the preferred polymer are predominantly urea linkages of the following structure:

(R¹—NH—C(=0)-NH—R²—NH—C(=0)-NH).

Isocyanate-amine polymerization reactions are preferred because no catalyst is required. The polymerization reaction can proceed at room temperature and heating is not required. Desired characteristics of the copolymer are determined through choice of diisocyanate and diamine terminated subunits.

Preferred copolymers of the invention satisfy the additional consideration that exposure of workers to toxic substances is limited.

It is preferred to practice the method of the invention using solvents having low toxicity, such as isopropyl alcohol. Other suitable solvents include, but are not limited to common industrial solvents and solvent blends of moderate to high polarity, such as alcohols, aromatic hydrocarbons, ethers, esters, ketones, glycol ethers, glycol ether esters, amides and mixtures thereof. Use of the preferred solvent imposes certain constraints, which will not be present when other aprotic solvents are employed. For example, isocyanates display a range of reactivity with alcohols, even in the absence of a catalyst. To reduce or eliminate side reactions with the preferred solvent, preferred isocyanates are chosen from those that are less reactive with isopropyl alcohol. For example, a preferred diisocyanate terminated hard segment is 1,3-bis(1-isocyanato-1-methylethyl)benzene. When other solvents are used, the range of useful isocyanates will differ. Proper selection of compatible solvents and reactants is well within the understanding of one or ordinary skill in the art of polymer chemistry.

Soft segments, hard segments and cross-linking segments which are reacted as set forth above to make copolymers of the invention will now be described.

Moisture vapor permeability is conferred on membranes of compositions of the invention by the incorporation of soft segments including hydrophilic monomeric or polymeric subunits into the copolymer. In certain embodiments, hydrophilic subunits are terminated by amines and are reacted with isocyanate-terminated subunits. The resulting linkages are primarily urea linkages. In preferred embodiments, the hydrophilic subunit is itself polymeric. A particularly preferred subunit is poly(oxyethylene) diamine (CAS# 65605-36-9), a linear polyether polymer terminated with two amine groups which has good solubility in isopropyl alcohol. Poly(oxyethylene) diamine is available in a range of molecular weights e.g., approximate molecular weights of 600, 900 and 2000 (available from Huntsman Chemical Co., Salt Lake City, Utah). In a preferred embodiment, the poly(oxyethylene) diamine is:

NH₂—(CH₃)—CH—CH₂—(O—(CH₃)—CH—CH₂)ₐ—(O—CH₂—CH₂—)_{b}—(O—(CH₃)—CH—CH₂)_{c}—NH₂

where b is about 15.5, a +c is about 2.5 and the number average molecular weight is about 900.

In general, moisture vapor permeability (MVP) is increased by increasing the proportion by weight of poly(oxyethylene) diamine monomer, e.g., by selecting the highest useful molecular weight monomer and/or by minimizing the proportion by weight of hard segment. Of course, it may be desirable to balance the composition of a polymer to favor other characteristics. Reducing the molecular weight of the poly(oxyethylene) diamine with no change in the molar ratio of the components of the polymerization reaction mixture will result in an increased proportion by weight of other constituents of the composition and of the resulting copolymer. The MVP will be reduced, as well as other soft segment characteristics such as stretch and flexibility.

In embodiments of the invention, the preferred poly(oxyethylene) diamine has a number average molecular weight of about 900. When the molecular weight is about 900, poly(oxyethylene) diamine is preferably used in the reaction mixture in an amount from about 40% to about 70% by weight of dissolved solids. More preferably, the poly(oxyethylene) diamine has a molecular weight of about 900 and is present in an amount from about 55% to about 65% by weight.

Other hydrophilic substances can be used with or instead of poly(oxyethylene) diamine according to the invention. Examples of such substances include, but are not limited to poly(oxyethylene) diols (which may require the use of heat or a catalyst to react).

Properties of copolymers of the invention can be altered by the addition or substitution of other soft segments. For example, a hydrophobic polyether may optionally be used in small amounts to reduce the MVP of the material or to reduce swelling that results from water absorption. Stretch of the final product is not reduced, and good mechanical integrity and hydrolysis resistance is retained. A preferred example of such a polyether is poly(oxypropylene) diamine (CAS #9046-10-0).

To obtain certain compositions of the invention, poly(oxypropylene) diamine is used in amounts ranging from 0% to about 5% by weight. To obtain preferred compositions, the amount of poly(oxypropylene) diamine is from 1% to 2% by weight. As with poly(oxyethylene) diamine, the molar amount of the poly(oxypropylene) diamine to be used will also depend on the average molecular weight of the poly(oxypropylene) diamine. Other hydrophobic monomeric or polymeric substances may of course be substituted. Examples of alternatives include, but are not limited to, polyethers, such as poly(oxybutylene) diamine and polyesters. Polyoxypropylene diol, polyoxybutylene diol and a wide variety of polyester diols, especially those derived from adipic, phthalic or isophthalic acids, are non-limiting examples of non-amino-terminated (hydroxyl-terminated) alternatives (which may require heat and/or catalysts for reactivity).

A variety of hard segment precursors can be used in the invention. To obtain copolymers having desirable characteristics, the molar ratio of hard segments to soft segment is usually greater than one. Where soft segments, as described above, are terminated with amines, hard segment precursors terminated with isocyanates are supplemented with hard segments terminated with amines. The hard segment precursors can be aromatic or aliphatic.

The preferred diisocyanate terminated hard-segment monomer is 1,3-bis(1-isocyanato-1-methylethyl)-benzene (mTMXDI, CAS# 2778-42-9). Examples of other diamine terminated hard segment precursors that are commercially available include isophorone diisocyanate (IPDI), toluene diisocyanate (TDI), diphenyl methane diisocyanate (MDI), dicyclohexyl methane diisocyanate (HMDI), and hexane diisocyanate (HDI, CS#28182-81-2). Preferred monomers have a relatively good toxicity profile for handling. Other monomers may be preferred if monomer toxicity is not a significant concern. Diisocyanate monomers are also selected on the basis of their reactivity. In general, the reaction of diisocyanates with amines requires no catalyst. However, the reactivity of the diisocyanate monomer will determine the extent of side reactions with the solvent. Preferred diisocyanate monomers for use with alcohol solvents, such as those listed above, have reduced reactivity with the alcohol solvent. The aforementioned diamines are suitable for use in protic or aprotic solvent systems.

The amount of hard segment monomer, such as mTMXDI, is selected in concert with other components of the reaction mixture to provide a final product with desired characteristics. Smaller proportions by weight result in a softer polymer with an increased MVP. Larger proportions increase hardness and result in a decreased MVP. Due to the preference for approximately equimolar amounts of reactive isocyanate and amine groups in the reaction mixture, an increase in the numerical amount of isocyanate terminated hard segment will be accompanied by an increase in the numerical amount of amine-terminated segments. This can be accomplished by substituting small diamine terminated reaction components for the larger diamine components, which contribute to MVP and/or softness (e.g., poly(oxyethylene) diamine, poly(oxypropylene) diamine).

For the combination of monomeric and polymeric components given in Table 1 (below), the amount of mTMXDI can be from about 15% to about 45% by weight, and is more preferably about 20% to about 35% by weight. Most preferably the amount is from 25% to about 30%. In other combinations, the amount of mTMXDI will depend on the selection of other components in the polymer. For example, in monomer combinations using diamine terminated soft segments of higher molecular weight, the weight percent of mTMXDI will be reduced. Similarly, if mTMXDI is substituted by a diisocyanate of higher molecular weight, the weight percent to use will increase. This relationship is made clear by the preference that amine and isocyanate moieties are used in approximately equal molar concentrations.

It will also be apparent that the ratio of soft segments to hard segments in copolymers of the invention will vary. For example, as used in moisture vapor permeable membranes, copolymers of the invention usually have a molar excess of hard segment precursors. Where all soft segment precursors are terminated with amines, it is apparent that both isocyanate terminated hard segment precursors and amine terminated hard segment precursors will be used.

As indicated above, copolymers of the invention which display desired combinations of characteristics usually comprise a ratio of hard segments to soft segments that is greater than one. Such copolymers can be obtained by including diamine terminated hard segments in the polymerization reaction. Thus, the amine terminated starting materials can comprise hard segments as well as soft segments. As previously noted, decreasing the proportion of soft segments and increasing the proportion of hard segments and/or cross-linking segments provides an increase in hardness and durability of the final product.

In a preferred embodiment, the diamine-terminated hard-segment precursor is 4,4′-methylenebis-cyclohexanamine (CAS# 1761-71-3). Examples of other aliphatic diamines that can be used include, but are not limited to 1,3-pentanediamine (Dytek EP, DuPont), 2-methylpentamethylenediamine (Dytek A, DuPont) and triethyleneglycoldiamine (Jeffamine EDR-192, Texaco). When the aliphatic diamine is 4,4′-methylenebis-cyclohexanamine, the amount present in a preferred composition is about 0 to about 20% by weight, more preferably about 4% to about 15% by weight, and most preferably about 8% to about 10% by weight.

It is desirable to employ small amounts of monomeric starting materials that provide for chain-branching in copolymers of the invention. For example, commercial grades of long chain diamine terminated soft segments disclosed above are somewhat “one-ended.” Among the diamine-terminated molecules are a significant number of molecules lacking one of the two reactive amine moieties that, in a polymerization reaction, act as chain terminators. Resulting polymeric compositions would therefore comprise polymer chains of limited length. The most significant effect is reduced strength of the polymer. Increasing the proportion of diamine-terminated soft segment is not a remedy as the proportion of chain terminating monoamines will remain unchanged.

However, the effect can be negated by the introduction of polymeric subunits capable of forming three or more urea linkages. Such starting materials can be polyisocyanates or polyamines. In certain embodiments of the present invention, the hard segment further comprises a polyfunctional element adapted to prevent premature termination of a backbone of the copolymer by forming at least three urea-linking groups, wherein the polyfunctional element is at least one of a polyisocyanate or a polyamine.

A preferred polyfunctional isocyanate is 1,6-diisocyanatohexane, homopolymer (CAS# 28182-81-2) or trifunctional isocyanate (CAS# 822-26-0). The amount of the polyfunctional isocyanate used depends on the molecular weight and degree of polyfunctionality. Desmodur N 3300 (Bayer) which is a homopolymer of 1,6-diisocyanatohexane with a molecular weight of about 330 and an isocyanate content of about 21.5%. The amount of Desmodur N 3300 to be used can range from about 0.25 to about 3% by weight. More preferably, the amount ranges from about 0.5 to about 3.0% by weight. Other useful aliphatic polyisocyanates include but are not limited to other members of the Desmodur series such as N-75, N-100, Z-4370 and XP-7014. Useful aromatic polyisocyanates include but are not limited to members of the Mondur (Bayer) series such as CB-60, IL, MR, CD and PF. As noted above for the diisocyanate component, the amount of trifunctional or polyfunctional isocyanate to be used is related to molecular weights of all of the monomeric and polymeric components of the reaction mixture. As indicated above, polyisocyanates are chosen where necessary to have reduced reactivity with solvents such as isopropyl alcohol.

An important element of the invention is the latent capacity for cross-linking exhibited by copolymers formed in the initial reaction mixture. The latent cure mechanism allows for formation of the copolymer-solvent composition into a desired configuration before formation of the cross-links. In preferred embodiments, cross-linking occurs by the moisture-activated reaction of pendent silane esters. Cross-linking segments are incorporated into the copolymer along with soft segments and hard segments in a random order. Cross-linking segment precursors are preferably pendent monomeric trifunctional alkoxysilanes, having a cross-linking group, preferably a pendant silane ester, and two groups, preferably terminal isocyanate and/or amine groups, which participate in polymerization and are incorporated into the copolymer in the polymerization step as polar linking groups. The third substituent, the pendant silane ester, remains unreacted until it is engaged in the cross-linking reaction. Usually, the cross-linking segment precursors will be different from soft segment and hard segment precursors. However, in certain embodiments, soft segments or hard segments may be used which further provide a cross-linking function.

In certain embodiments of the present invention, the cross-linking segment is a member selected from the group consisting of γ-aminopropyltriethoxysilane, γ-isocyanatopropyltriethoxysilane, bis(γ-trimethoxysilylpropyl)amine, and N-(3-(trimethoxysilyl)propyl)-1,2-ethanediamine. Preferably, the cross-linking segment is N-(3-(trimethoxysilyl)propyl)-1,2-ethanediamine. The amount of the cross-linking segment is from about 0.5% to about 5%, preferably from 1.5 wt % to 2.5 wt %.

Although the preferred monomer has two reactive amines, other monomers can be used. For example, a monomer can have reactive isocyanates and a functional silane. Other monomers, which can be used, have a single reactive amine or isocyanate in addition to the functional silane. Although such monomers will terminate polymer chains into which they are incorporated, polymer size can be increased by introducing chain branches as indicative above. Examples of useful silanes include, but are not limited to, y-aminopropyltriethoxysilane, y-isocyanatopropyltriethoxysilane and bis-(γ-trimethoxysilylpropyl)amine.

It is understood that in certain embodiments, cross-linking segments may coincide with hard segments or soft segments. For example, a starting material can be selected which imparts both hard segment characteristics and latent cross-linking capacity to the copolymer formed in the polymerization reaction.

It is also to be understood that the reactive terminal groups on soft and hard segment starting materials need not be arranged as generally outlined above. There is no requirement that hard segments be terminated with isocyanates or that soft segments be terminated with amines. Furthermore, silane-containing monomers can be terminated with isocyanates or amines.

Selected monomers and their proportions by weight in a particular preferred embodiment are summarized in Table 1.

TABLE 1
Composition of Preferred Reaction Mixture by Weight

| Subunit; Approximate MW (CAS #) | Wt % |
|---|---|
| Poly(oxyethylene) diamine; 900 (65505-36-9) | 55-65 |
| Poly(oxyethylene) diamine; 2000 (9046-10-0) | 1-2 |
| 4,4′-methylenebiscyclohexanamine; 210 (1761-71-3) | 8-10 |
| 1,3-bis(1-isocyanato-1-methylethyl) benzene; 244 (2779-42-9) | 25-30 |
| 1,6-diisocyanatohexane, homopolymer; 388 (28182-81-2 | 0.5-1.5 |
| N-(3-(trimethoxysily)propyl)-1,2-ethanediamine; 222 | 1.5-2.5 |
| (1760-24-3) | |

To prepare the preferred composition, the components are blended into isopropanol to provide a solution, which is 30% solids by weight. The amounts are selected so that the molar ratio of terminal isocyanates to terminal amines is about 1:1. In practice, amine terminate components are first blended into a uniform isopropanol solution. Isocyanate terminated components are weighed, blended together, and slowly added to the isopropanol solution with stirring until a viscosity of 500-5000 cp is obtained. As a result of lot-to-lot variations in the starting materials, the actual isocyanate:amine ratio of the weighed chemicals will not always be 1:1. Therefore, the blended isocyanates are added to the solution until the desired viscosity is obtained. To reduce viscosity, additional solvent can be added.

Additional optional components, which can be added, include pigments, anti-oxidants, wetting agents, catalysts, stabilizers, etc. For example, a catalyst such as 0.05 pph dibutyltin dilaurate may be used to assist silane ester curing of the polymer.

When the starting materials and resulting copolymer are dissolved according to the invention, the pendant silane esters of the cross-linking segments are substantially non-reactive. Curing is delayed until the solvent is removed and moisture becomes available to catalyze the cross-linking reaction. Interchain and intrachain cross-linking occurs when the silane esters react to form R—Si—O—Si—R linkages.

This invention also provides a cross-linked copolymer, wherein cross-linking is effectuated by coupling of pendent alkoxysilanes in a presence of H₂O. Preferably, cross-linking is effectuated by coupling of pendent alkoxysilanes in the presence of H₂O. In a preferred embodiment, the membrane is cured by simple exposure to ambient humidity.

This invention also relates to a membrane formed from the cross-linked copolymer, wherein the membrane has a moisture vapor permeability of at least about 250 g/m²-24 hr, preferably the moisture vapor permeability is at least about 500 g/m²-24 hr, and more preferably, the moisture vapor permeability is at least about 1000 g/m²-24 hr.

Membranes formed from the copolymer of the invention are moisture vapor permeable. In one embodiment, a membrane is formed which comprises a copolymer of the invention in an amount of about 0.5 oz/yd² (about 17 g/m²) and a thickness of about 0.00075 inches (0.01905 mm). The moisture vapor permeability is 1075 gm/m²-24 hr. It will be appreciated that the moisture vapor permeability of compositions of the invention will be related to the thickness of the membrane as well as to the proportion and type of soft segment utilized. In embodiments of the invention, membranes comprising compositions of the invention have moisture vapor permeability greater than about 500 g/m²-24 hr. In certain embodiments, the moisture vapor permeability is greater than about 500 g/m²-24 hr. In a particularly preferred embodiment, the moisture vapor permeability is greater than about 1000 g/m²-24 hr.

Typically, membranes composed of compositions of the invention are bonded to a fabric to form 2-ply or 3-ply structures. For example, a dot pattern of adhesive can be applied to one or both surfaces of the membrane to bond one or two layers of fabric.

Following evaporation of solvent and curing, the composition is in the form of a self-supporting film or membrane, which can be separated from the auxiliary substrate (it should be understood that dried uncured membranes are also self-supporting even though they exhibit greater surface tack). It is preferred to form the composition into continuous sheets or films by methods such as spray, knife, roll, wire-wound rod, rotogravure, rotary screen, or extrusion, with knife and reverse-roll methods being most preferred.

Films and membranes formed by such methods can be of any desired shape. Membranes conformed to anatomical shapes can be produced, for example, by casting the copolymer on molds of a desired shape before cross-linking. For example, a one piece membrane for incorporation in a breathable water-resistant glove can be made by coating the copolymer on a form having the overall shape of a hand. The elasticity of the finished membrane allows easy removal from the form.

This invention also relates to a method of making the copolymer of the invention. The method includes (1) providing a reaction vessel, (2) combining in the reaction vessel: (a) a soft segment precursor, the soft segment precursor comprising a hydrophilic portion and up to 30 wt % of a hydrophobic portion based on the total dry weight of the polymer composition, (b) a hard segment precursor comprising a hard segment, and (c) a cross-linking segment precursor comprising a cross-linking segment having a pendant alkoxysilane, wherein each of the soft segment precursor, the hard segment precursor, and the cross-linking segment precursor comprise at least two functional groups having a functionality of at least 2, the at least two functional groups include an amino group and/or an isocyano group, (3) adding to the reaction vessel a polar organic solvent, preferably isopropanol in the amount of up to 30 wt % solids; and (4) reacting the at least two functional groups to form the copolymer. In certain embodiments of the present invention, the method further includes (5) forming a diamine mixture by combining in a diamine blend vessel prior to combining in the reaction vessel the soft segment precursor, the hard segment precursor, and the cross-linking segment precursor, wherein the at least two functional groups are amino groups, (6) combining in an isocyanate blend vessel at least two polyfunctional isocyanates having a functionality of at least 2 to form an isocyanate mixture, and (7) combining the diamine mixture and the isocyanate mixture in the reaction vessel to form the copolymer.

Further, this invention relates to a method of making a moisture vapor permeable membrane. The method includes providing a reaction vessel, combining in the reaction vessel poly(oxyethylene) diamine in an amount from about 20 wt % to about 70 wt %; poly(oxypropylene) diamine in an amount from about 0 wt % to about 5 wt %; 4,4′-methylenebiscyclohexanamine in an amount from about 0 wt % to about 20 wt %; 1.3-bis(1-isocyanato-1-methylethyl) benzene in an amount from about 15 wt % to about 45 wt %; 1,6-diisocyanatohexane, homopolymer in an amount from 0.25 wt % to about 3 wt %; and N-(3-(trimethoxysilyl) propyl)-1,2-ethanediamine in an amount for about 0.5 wt % to about 5 wt %, adding isopropanol to the reaction vessel to form a viscous copolymer solution, shaping the viscous copolymer solution to form a thin layer, substantially removing the isopropananol, and curing the copolymer to obtain a cross-linked copolymer by exposure to moisture, thereby forming the moisture vapor permeable membrane.

Preferably, the copolymer is semi-solid and is formed into a membrane by coating or extruding onto an auxiliary surface. The auxiliary substrate provides a surface suitable to retain a coating of the copolymer in its viscous state, but which does not adhere permanently to the membrane once the solvent is evaporated and the cross-links formed. Auxiliary substrates, which do not become incorporated into a final product, are widely used to support materials in an unfinished state. See, e.g., U.S. Pat. No. 4,035,532 (lamination of flocking to a fabric), U.S. Pat. No. 5,889,073 (production of material having a hydrophilic surface), and U.S. Pat. No. 5,458,911 (production of a self-supporting thick-film structure). The preferred auxiliary substrate is a sheet of 0.002″ thick biaxially-oriented polypropylene. Other suitable auxiliary substrates are well known to one of ordinary skill in the art.

Preferably, the moisture vapor permeable membrane is bonded to at least one textile surface, and more preferably are sandwiched between textile surfaces.

The invention will be illustrated in more detail with reference to the following Examples, but it should be understood that the present invention is not deemed to be limited thereto.

### EXAMPLES

### Example 1

### Manufacture of a Flat Membrane

817 kg of isopropanol (70% of final volume) was poured into a vessel. To the vessel were added 210 kg of poly(oxyethylene) diamine (Jeffamine XTJ-501, Huntsman), 3.5 kg of poly(oxypropylene) diamine (Jeffamine D-2000, Huntsman), 30 kg of 4,4′-methylenebiscyclohexanamine (Amicure® PACM, Air Products and Chemicals, Inc.) and 7.5 kg of N-(3-(trimethoxysilyl) propyl)-1,2-ethanediamine (Union Carbide). The contents were blended to a uniform solution.

92 kg of 1,3-bis(1-isocyanato-1-methylethyl) benzene (Cytec) and 7 kg of 1,6-diisocyanatohexane homopolymer (Desmodur N 3300, Bayer) were preweighed and blended in a separate container. The mixture of 1,3-bis(1-isocyanato-1-methylethyl)benzene and 1,6-diisocyanatohexane homopolymer slowly added to the isopropanol solution with constant agitation until a viscosity of 3800-4500 centipoises at 115° F. (46.1° C.). Viscosity was measured by utilizing a Brookfield RVT viscometer. If necessary, viscosity can be reduced by the addition of more solvent (e.g., isopropanol).

A film prepared from this solution was drawn down onto a sheet of 0.002″ (0.005 mm) thick biaxially-oriented polypropylene and air dried at ambient temperature.

### Example 2

### Physical and Chemical Properties

### Water Absorption

A membrane was prepared according to Example 1. The film on the polypropylene sheet was air dried at ambient conditions until relatively tack free. The coated sheet was further exposed to 150° F. (65.6° C.) in a circulating air oven for approximately 16 hours to remove all traces of solvent.

Immediately upon removal from the oven, a circular specimen was die cut from the coated sheet. After removing the polypropylene backing, the specimens were weighed on an electronic balance and immersed in distilled water contained in a closed Petri dish maintained at approximately 71° F. (21.7° C.).

At regular intervals following immersion, the specimen was removed from the distilled water, blotted dry with paper towels, and then weighed. This procedure was followed until no further weight gain was detected in any 24 h period.

Percent water absorption was calculated as 100×(W_{f}−Wᵢ)Wᵢ where Wᵢ=initial weight and Wⱼ=final weight and was determined to be 280%. The relatively high absorption reflects the polymer's relatively high degree of hydrophilicity.

### Miscellaneous Textile Laminate Properties

The following properties were determined on laminate samples prepared from polyester fleece, polyurethane adhesive, and membranes of the new chemical substance.

To prepare membranes suitable for these samples, a 30 wt. % solids solution of the preferred chemical substance in isopropanol was compounded with antioxidant (0.5 phr or parts per hundred parts resin), silicone wetting agent (0.5 phr), organotin catalyst (0.05 phr) and additional isopropanol to a final solids content of approximately 25 wt. %. The resulting solution compounds were cast onto 0.0002″ (0.005 mm) thick biaxially-oriented polypropylene film and dried at 150OF (65.6° C.) for 2 minutes. In this manner, clear defect-free polymer films that stripped easily from their plastic substrates were produce in a variety of thicknesses.

Rectangular sections of polyester knit fleece were bonded to both surfaces of these films using two-component polyurethane solution adhesive deposited in a dot pattern. Using this procedure, fleece-film-fleece laminates of very soft “handle” were produced that exhibited a high moisture vapor transmission rate, good waterproofness, and excellent durability to laundering.

TABLE 2
Summary of Laminate Properties

| New Chemical | Moisture | | Durability to | Hydrostatic |
|---|---|---|---|---|
| Substance | Vapor | | Continuous | Resistance |
| Membrane | Trans- | Hydrostatic | Warm Water | after 48 h |
| Weight | mission¹ | Resistance² | Laundering | Laundering |
| (oz/yd²) | (g/m²-24 h) | (psi) | (h) | (psi) |
| 0.2 | 1,343 | 6.5 | >48 | 0 |
| 0.25 | 1,170 | 15 | >48 | 0 |
| 0.5 | 1,075 | 24 | >48 | 13 |
| 0.6 | 970 | 33 | >48 | 23 |

¹ASTM E 96-94, procedure B at 50% RH and 23° C.
²ASTM D751 (Mullen hydrostatic procedure)

For any given type of moisture vapor permeable (MVP) membrane, there exists an optimal balance of opposing properties. Typically, soft, drapeable membranes engineered for high breathability sacrifice some laundering durability due to either their inherent moisture sensitivity (hydrophilic types), or via contamination from surface tension lowering agents, such as detergent residue (microporous types). The measurement of hydrostatic resistance (waterproofness) versus laundering represents a convenient way to characterize MVP materials' suitability for an intended apparel application. Table 2 shows that membranes of the invention having a weight of about 0.5 to about 0.6 oz/yd² exhibit good retention of hydrostatic resistance even after rigorous exposure to laundering.

### Solution Stability

Freshly prepared solutions of the copolymer substance at 25 and 30 wt % solids were measured for viscosity at regular intervals utilizing a Brookfield Model RVT viscometer. The solutions typically could be stored for 2-3 weeks at room temperature before being formed into a membrane. The solution typically increased in viscosity over time at room temperature with some batches reaching gelation within one week while others retained stability for one month or more. Gelation is presumably due to hydrolysis of the silane ester groups distributed along the polymer backbone, leading to eventual interchain and intrachain cross-linking via Si—O—Si linkages.

### Cure Response of Free Films

Free films of the new chemical substance were cast by a procedure analogous to that described above under “Water Absorption,” except that the films were exposed to 150° F. (65.6° C.) for several minutes only. These films were subsequently aged at room temperature and tested at regular intervals for solubility in anhydrous isopropyl alcohol. At the point in time where the films,appeared to merely swell in the test solvent, yet maintain shape, they were presumed to be “cured.” The mechanism in this curing reaction is assumed to be a chemical cross-linking identical to that described above under “Solution Stability.”

Films aged at ambient conditions attain cure within a few weeks in the absence of external catalyst, whereas films containing 0.05 pph dibutyltin dilaurate cure in less than 24 h.

### Example 3

### Incorporation into Textile Products

Incorporation of compositions of the invention into textile products would typically involve either the direct or transfer coating of a suitable textile substrate employing solution compounds of the polymer, or alternatively the lamination of cured preformed supported membrane using adhesives systems well known in the art. The resulting coated fabrics can then be fashioned into clothing articles just as conventional fabrics are. For many apparel applications, the lamination of a second open mesh fabric to the otherwise exposed membrane surface is desirable for both protection of the membrane as well as seam sealing tape receptivity.

A particularly promising application of the invention relating to textile products involves the transfer coating of expanded PTFE (ePTFE) membrane with dried but uncured thin film of polymer cast onto a temporary carrier. After curing at ambient temperature, the resulting bilayer membrane can be stripped from its supporting carrier, laminated to a desired textile and subsequently fashioned into various waterproof, breathable articles. It is expected that this method will improve upon the method of coating ePTFE with HYPOL; which latter method is disclosed in U.S. Pat. No. 4,194,041 (see Examples).

While the invention has been described in detail and with reference to specific examples thereof, it will be apparent to one skilled in the art that various changes and modifications can be made therein without departing from the spirit and scope thereof.

What is claimed is:

1. A copolymer comprising a random distribution of:
a soft segment comprising a hydrophilic soft segment and optionally a hydrophobic soft segment, wherein the hydrophobic soft segment constitutes up to 30 wt % of the copolymer;
a hard segment;
a cross-linking segment comprising a pendant alkoxysilane; and
at least two terminal groups comprising at least one of an amine and an isocyanate having a functionality of at least 2,
wherein a number average molecular weight (Mₙ) of the copolymer is at least about 10,000.

2. The copolymer of claim 1, wherein the hydrophilic soft segment constitutes 20 to 70 wt % of the copolymer.

3. The copolymer of claim 2, wherein the hard segment is in molar excess of the soft segment.

4. The copolymer of claim 2, wherein the hydrophilic soft segment is poly(oxyethylene) diamine with a number average molecular weight of at least 600.

5. The copolymer of claim 4, wherein the number average molecular weight of the hydrophilic soft segment is at least 900.

6. The copolymer of claim 4, wherein poly(oxyethylene) diamine is present in an amount of from about 55 wt % to about 65 wt %.

7. The copolymer of claim 2, wherein the hydrophobic soft segment is a member selected from the group consisting of poly(oxypropylene)diamine and poly(oxybutylene)diamine.

8. The copolymer of claim 7, wherein the hydrophobic soft segment is poly(oxypropylene) diamine present in an amount up to 30 wt %.

9. The copolymer of claim 2, wherein the hard segment comprises at least one of an isocyanate terminated hard segment and an amino terminated hard segment.

10. The copolymer of claim 9, wherein the isocyanate terminated hard segment is a member selected from the group consisting of isophorone diisocyanate (IPDI), toluene diisocyanate (TDI), diphenyl methane diisocyanate (MDI), dicyclohexyl methane diisocyanate (HMDI), hexane diisocyanate, and 1,3-bis(1-isocyanato-1-methylethyl)benzene and the amino terminated hard segment is a member selected from the group consisting of 4,4′-methylenebis-cyclohexanamine, 1,3-pentanediamine, 2-methylpentamethylenediamine, isophorone diamine and triethyleneglycoldiamine.

11. The copolymer of claim 10, wherein the isocyanate terminated hard segment is 1,3-bis(1-isocyanato-1-methylethyl) benzene present in an amount from about 15 wt % to about 45 wt %.

12. The copolymer of claim 11, wherein the isocyanate terminated hard segment is present in an amount from 20 wt % to 35 wt %.

13. The copolymer of claim 11, wherein the isocyanate terminated hard segment is present in an amount from 25 wt % to 30 wt %.

14. The copolymer of claim 10, wherein the amino terminated hard segment is 4,4′-methylenebis-cyclohexanamine present in an amount from 0 to about 20 wt %.

15. The copolymer of claim 14, wherein the amino terminated hard segment in an amount from 4 wt % to 15 wt %.

16. The copolymer of claim 14, wherein the amino terminated hard segment is present in an amount from 8 wt % to 10 wt %.

17. The copolymer of claim 9, wherein the hard segment further comprises a polyfunctional element adapted to prevent premature termination of a backbone of the copolymer by forming at least three urea linking groups, wherein the polyfunctional element is at least one of a polyisocyanate or a polyamine.

18. The copolymer of claim 17, wherein the polyfunctional element is at least one of 1,6-diisocyanatohexane homopolymer or trifunctional isocyanate represented by Chemical Abstracts No. 822-26-0.

19. The copolymer of claim 17, wherein the polyfunctional element is 1,6-diisocyanatohexane homopolymer present in an amount from about 0.25 wt % to about 3 wt %, and has a number average molecular weight of about 330 and an isocyanate content of about 21.5 wt %.

20. The copolymer of claim 2, wherein the cross-linking segment is a member selected from the group consisting of y-aminopropyltriethoxysilane, γ-isocyanatopropyltriethoxysilane, bis(γ-trimethoxysilylpropyl)amine, and N-(3-(trimethoxysilyl)propyl)-1,2-ethanediamine.

21. The copolymer of claim 20, wherein the cross-linking segment is N-(3-(trimethoxysilyl)propyl)-1,2-ethanediamine present in an amount from about 0.5% to about 5%.

22 The copolymer of claim 21, wherein the cross-linking segment is present in an amount from 1.5 wt % to 2.5 wt %.

23. The copolymer of claim 2, wherein each of the soft segment, the hard segment, and the cross-segment further comprises a linking group containing a urea linking group (—N—C(=0) -N—) and/or a urethane linking group (—O—C(=0) -N—), wherein the linking group is a formed by a reaction of the at least two terminal groups reacting at an amino/isocyano group molar ratio of 1:1.

24. A copolymer comprising a product of random polymerization of:
(a) a soft segment precursor, comprising at least two soft segment terminal groups, a hydrophilic soft segment and a hydrophobic soft segment, wherein the hydrophobic soft segment constitutes up to 30 wt % of the copolymer;
(b) a hard segment precursor, comprising at least two hard segment terminal groups and a hard segment; and
(c) a cross-linking segment precursor, comprising at least two cross-linking segment terminal groups and a cross-linking segment comprising a pendant alkoxysilane,
wherein the at least two soft segment terminal groups, the at least two hard segment terminal groups, and the at least two cross-linking segment terminal groups are members selected from the group consisting of amines, polyamines, isocyanates, and polyisocyanates, provided that the amines or the polyamines are reacted with the isocyanates or the polyisocyanates at an amino/isocyano group molar ratio of 1:1, and wherein the number average molecular weight of the copolymer is at least about 10,000.

25. The copolymer of claim 24, wherein the hard segment precursor is in molar excess of the soft segment.

26. The copolymer of claim 24, wherein the hard segment further comprises a polyfunctional element adapted to prevent premature termination of a backbone of the copolymer by forming at least three urea linking groups, wherein the polyfunctional element is at least one of a polyisocyanate and a polyamine.

27. The copolymer of claim 24, wherein the hydrophilic soft segment constitutes 20-70 wt % of the copolymer and the hydrophobic soft segment constitutes 1-5 wt % of the copolymer.

28. A copolymer of a formula:
NH₂-(A1-B3)ₓ-(A1-B2)_{y}-(A2-B2)_{z}-(C-B2)ₙ-(B1-B2)ₘ-(A1)-NH₂
where A1 is a hydrophilic soft segment, A2 is a hydrophobic soft segment, B1 is an amino terminated hard segment, B2 is an isocyanate terminated hard segment, B3 is a polyfunctional element, C is a cross-linking segment comprising a pendant alkoxysilane, x=1, y=14, z=0.1, n=2, and m=10, provided that A1, A2, B1, B2, B3, and C are distributed randomly, wherein the hydrophobic soft segment constitutes up to 30 wt % of the copolymer.

29. The copolymer of claim 28, wherein
the hydrophilic soft segment is poly(oxyethylene) diamine with a number average molecular weight of about 900 present in an amount of from about 55 wt % to about 65 wt %;
the hydrophobic soft segment is poly(oxypropylene) diamine with a number average molecular weight of about 2000 present in an amount of up to 30 wt %;
the amino terminated hard segment is 4,4′-methylenebis-cyclohexanamine present in an amount from about 8 wt % to about 10 wt %;
the isocyanate terminated hard segment is 1,3-bis(1-isocyanato-1-methylethyl) benzene present in an amount from 25 wt % to about 30 wt %;
the polyfunctional element is 1,6-diisocyanatohexane homopolymer with a number average molecular weight of about 330 present in an amount from about 0.5 wt % to about 1.5 wt %; and
the cross-linking segment is N-(3-(trimethoxysilyl)propyl)-1,2-ethanediamine present in an amount from about 1.5 wt % to about 2.5 wt %.

30. A cross-linked copolymer of claim 2, wherein cross-linking is effectuated by coupling of pendent alkoxysilanes in a presence of H₂O.

31. A cross-linked copolymer of claim 28, wherein cross-linking is effectuated by coupling of pendent alkoxysilanes in a presence of H₂O.

32. A membrane formed from a cross-linked copolymer of claim 31, wherein the membrane has a moisture vapor permeability of at least about 250g/m²-24 hr.

33. The membrane of claim 30, wherein the moisture vapor permeability is at least about 500g/m²-24 hr.

34. The membrane of claim 30, wherein the moisture vapor permeability is at least about 1000g/m²-24 hr.

35. A method of making a copolymer of claim 1, the method comprising:
providing a reaction vessel;
combining in the reaction vessel: (a) a soft segment precursor, the soft segment precursor comprising a hydrophilic portion and up to 30 wt % of a hydrophobic portion, (b) a hard segment precursor comprising a hard segment, and (c) a cross-linking segment precursor comprising a cross-linking segment having a pendant alkoxysilane, wherein each of the soft segment precursor, the hard segment precursor, and the cross-linking segment precursor comprise at least two functional groups having a functionality of at least 2, the at least two functional groups include an amino group and/or an isocyano group;
adding to the reaction vessel a polar organic solvent; and
reacting the at least two functional groups to form the copolymer.

36. The method of claim 35, further comprising:
forming a diamine mixture by combining in a diamine blend vessel prior to combining in the reaction vessel the soft segment precursor, the hard segment precursor, and the cross-linking segment precursor, wherein the at least two functional groups are amino groups;
combining in an isocyanate blend vessel at least two polyfunctional isocyanates having a functionality of at least 2 to form an isocyanate mixture; and
combining the diamine mixture and the isocyanate mixture in the reaction vessel to form the copolymer.

37. The method of claim 35, wherein the polar organic solvent is isopropanol present in an amount of up to 30 wt % solids.

38. A method of making a cross-linked copolymer comprising contacting a copolymer of claim 28 with H₂O to crosslink the copolymer by coupling of pendent alkoxysilanes.

39. The method of claim 38, further comprising applying the copolymer to a textile and contacting the copolymer on the textile with H₂O to crosslink the copolymer and form a vapor barrier layer.

40. The method of claim 38, further comprising using a catalyst to assist crosslinking of the polymer by coupling of pendent alkoxysilanes.

41. The method of claim 40, wherein the catalyst is dibutyltin dilaurate present in an amount of at least 0.05 pph.

42. The method of claim 38, wherein the cross-linked copolymer is provided in a form of a membrane.

43. A moisture vapor permeable membrane prepared by the method of claim 42.

44. A method of making a moisture vapor permeable membrane, the method comprising:
providing a reaction vessel;
combining in the reaction vessel poly(oxyethylene) diamine in an amount from about 20 wt % to about 70 wt %; poly(oxypropylene) diamine in an amount from about 0 wt % to about 5 wt %; 4,4′-methylenebiscyclohexanamine in an amount from about 0 wt % to about 20 wt %; 1.3-bis(1-isocyanato-1-methylethyl) benzene in an amount from about 15 wt % to about 45 wt %; 1,6-diisocyanatohexane, homopolymer in an amount from 0.25 wt % to about 3 wt %; and N-(3-(trimethoxysilyl) propyl)-1,2-ethanediamine in an amount for about 0.5 wt % to about 5 wt %;
adding isopropanol to the reaction vessel to form a viscous copolymer solution;
shaping the viscous copolymer solution to form a thin layer;
substantially removing the isopropananol; and
curing the copolymer to obtain a cross-linked copolymer by exposure to moisture, thereby forming the moisture vapor permeable membrane.

45. The method of claim 44, wherein the cross-linked copolymer is semi-solid and is formed into a membrane by coating onto an auxiliary surface.

46. The method of claim 44, wherein the cross-linked copolymer is semi-solid and is extruded.

47. The method of claim 44, wherein the moisture vapor permeable membrane is bonded to at least one textile surface.
